(19) United States
(12) Patent Application Publication
(10) Pub. No.: US 2006/0093119 A1
(43) Pub. Date: May 4, 2006

(54) Leveraging real-time communications client

(76) Inventors: Richard A. Wilson JR., Temecula, CA (US); Paul J. Chen, Huntington Beach, CA (US); James J. DePoy, Corona del Mar, CA (US)

Correspondence Address: Canon U.S.A. Inc.;Intellectual Property Department, 15975 Alton Parkway, Irvine, CA, 92618, US

(21) Appl. No.: 11/252,348

(22) Filed: Oct. 17, 2005

Related U.S. Application Data
(60) Provisional application No. 60/624,606, filed on Nov. 3, 2004.

(51) Int. Cl. H04M 3/42

(52) U.S. Cl. 379/211.02; 709/206; 370/352

(57) ABSTRACT

A system and method for communicating between at least two Instant Messaging enabled devices includes registering the at least two instant messaging enabled devices, adding an instant messaging identity associated with the at least two instant messaging enabled devices at at least one of the instant messaging enabled devices other than the at least one instant messaging enabled device associated with the instant messaging identity, initiating an Instant Messaging session between a first and a second of the at least two instant messaging enabled devices, receiving device information from the first of the at least two instant messaging enabled devices at the second of the at least two instant messaging enabled devices, determining, based on the received identification information, whether the first of the at least two instant messaging enabled devices supports a service or function sought by the second of the at least two instant messaging enabled devices, requesting performance of a service or function based on the determination, and performing the requested service or function.

### CROSS-REFERENCE TO RELATED APPLICATION

This application claims the benefit of U.S. Provisional Application No. 60/624,606, filed Nov. 3, 2004, which is hereby incorporated by reference in its entirety.

### BACKGROUND OF THE INVENTION

1. Field of the Invention

The present invention relates to providing real-time device access, monitoring, command, and control employing messaging according to real-time interactive communications protocol.

2. Description of the Related Art

Data networks have become commonplace for interconnecting various elements such as personal computers, computer peripherals (i.e., printer), servers, etc. The elements making up a data network have traditionally been connected via cables and wires, while more recently the connection has been accomplished wirelessly. Data networks are usually either public networks, such as the Internet, or private, local networks. Typical forms of communications between the elements on the data network include e-mail messages and file transfers.

Recently, a significant number of people have begun to communicate using real-time interactive communication protocols, such as Instant Messaging. In an Instant Messaging environment, a user is able to, among other things, communicate with friends and/or co-workers in real-time, receive real-time up-to-date news, or receive notifications from a vendor's web site based on the user's pre-defined settings. It is features such as this that have helped increase the popularity of Instant Messaging. One aspect of Instant Messaging that has made it popular is its use of a presence capability. Presence capability allows users who are logged into a particular Instant Messaging application to know when other parties are available. Presence information typically manifests itself as the “buddy list” of the Instant Messaging application.

Until recently, Instant Messaging was only being used for communication between users. One early drawback to the implementation of Instant Messaging was that it only made use of presence information relating to users. In other words, early Instant Messaging applications only supported user-to-user communication. As a result, the communication, e.g., the transfer of text messages, photos, etc., occurred only between users, where each user was logged into their respective Instant Messaging application.

Recently, the Instant Messaging has begun to encompass communication between users and devices. For example, Instant Messaging is being used to send commands to and receive data from various devices. The same principles, i.e., use of Instant Messaging presence capability, that has been used in the user-to-user environment are applicable in the user-to-device environment. These principles are also applicable in device-to-device environments, where events on one instant messaging enabled device trigger events on other instant messaging enabled devices. For example, an instant messaging enabled digital camera transferring digital images to an instant messaging enabled storage device (e.g., storage server)

Despite the recent advances in the use of Instant Messaging, the current implementations have not taken advantage of all the capabilities provided by Instant Messaging protocols in device-to-device environments.

Given the popularity of Instant Messaging applications, what is needed is an Instant Messaging process that takes advantage of all the capabilities provided by Instant Messaging protocols for device-to-device communications.

### SUMMARY OF THE INVENTION

The forgoing problem is addressed by a method and system that makes use of all the capabilities provided by Instant Messaging protocols for device-to-device communications.

In an aspect of the present invention, a system and method for communicating between at least two instant messaging enabled devices includes registering the at least two instant messaging enabled devices, adding an instant messaging identity associated with the at least two instant messaging enabled devices at at least one of the instant messaging enabled devices other than the at least one instant messaging enabled device associated with the instant messaging identity, initiating an Instant Messaging session between a first and a second of the at least two instant messaging enabled devices, receiving device identification information from the first of the at least two instant messaging enabled devices at the second of the at least two instant messaging enabled devices, determining, based on the received identification information, whether the first of the at least two instant messaging enabled devices supports a service or function sought by the second of the at least two instant messaging enabled devices, requesting performance of a service or function based on the determination, and performing the requested service or function.

The present invention allows for full use of the capabilities provided by Instant Messaging by providing for direct instant messaging communication between instant messaging enabled devices. Further features of the present invention will become apparent from the following description of the exemplary embodiments, with reference to the attached drawings.

### BRIEF DESCRIPTION OF THE DRAWINGS

FIG. 1 is a representational view of the general configuration of the system of the present invention.

FIGS. 2-2D are flowcharts describing an instant messaging enabled device's process according to the present invention.

FIG. 3 depicts the architecture of an RTC client and an RTDC Client according to the present invention.

FIG. 4 is one example of implementing the instant messaging system of the present invention.

FIG. 5 is another example of implementing the instant messaging system of the present invention.

FIG. 6 is yet another example of implementing the instant messaging system of the present invention.

FIG. 7 is still yet another example of implementing the instant messaging system of the present invention.

### DETAILED DESCRIPTION OF THE INVENTION

The invention is described by way of an exemplary embodiment, but it is understood that the description is not intended to limit the invention to this embodiment, and is intended to cover alternatives, equivalents, and modifications such as are included within the scope of the appended claims.

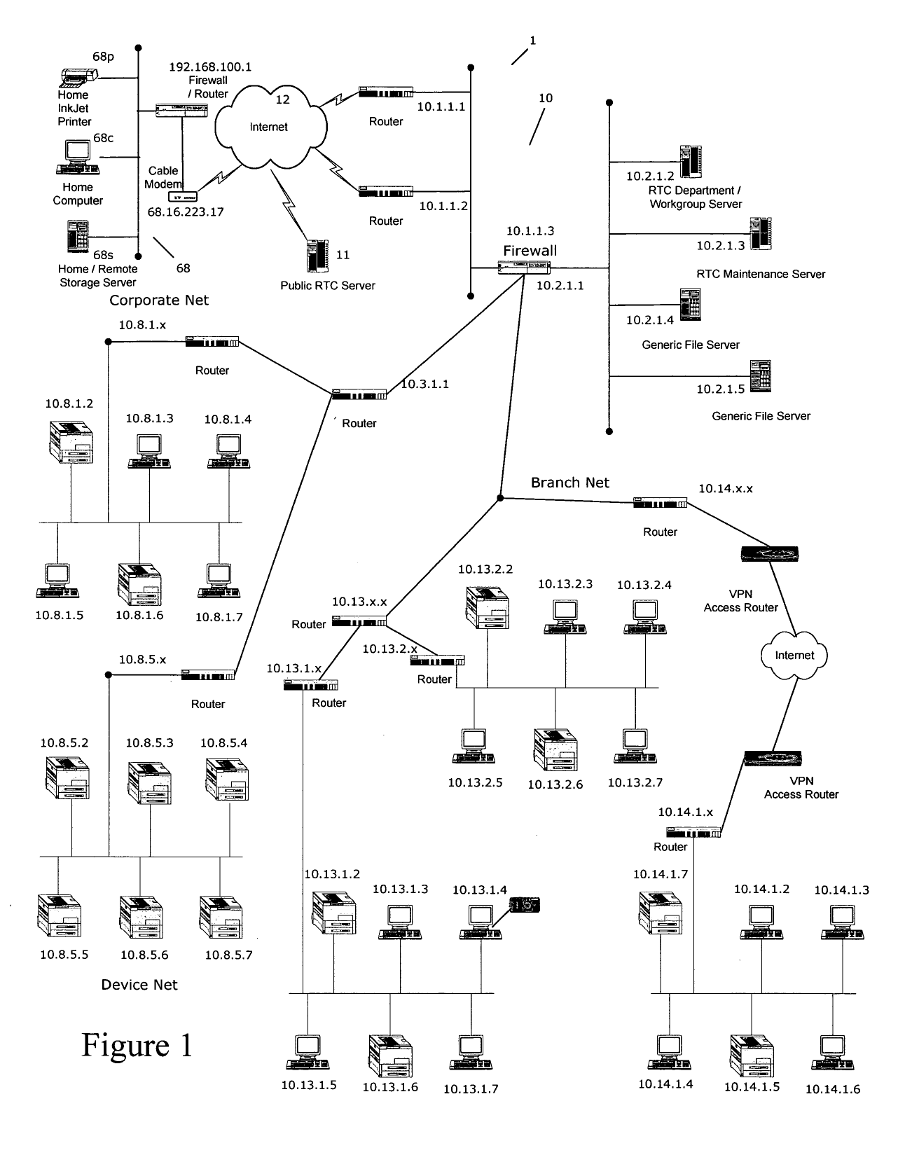

FIG. 1 is a representational view of a system 1 in which instant messaging enabled devices communicate with each other. System 1 includes instant messaging enabled devices 10.13.2.3, 10.2.1.4, 68p, and 68s. Instant messaging enabled devices 10.13.2.3 and 10.2.1.4 are part of network 10, while instant messaging enabled devices 68p and 68s are part of home network 68. Network 10 is remote from home network 68, but network 10 and network 68 are connected via the Internet 12. Instant messaging enabled devices 10.13.2.3, 10.2.1.4, 68p, and 68s are personal computers, printers, and servers. However, any instant messaging enabled device, such as a personal data assistant (PDA), cellular phone (camera and non-camera enabled), etc. that would enable practice of the present invention is applicable.

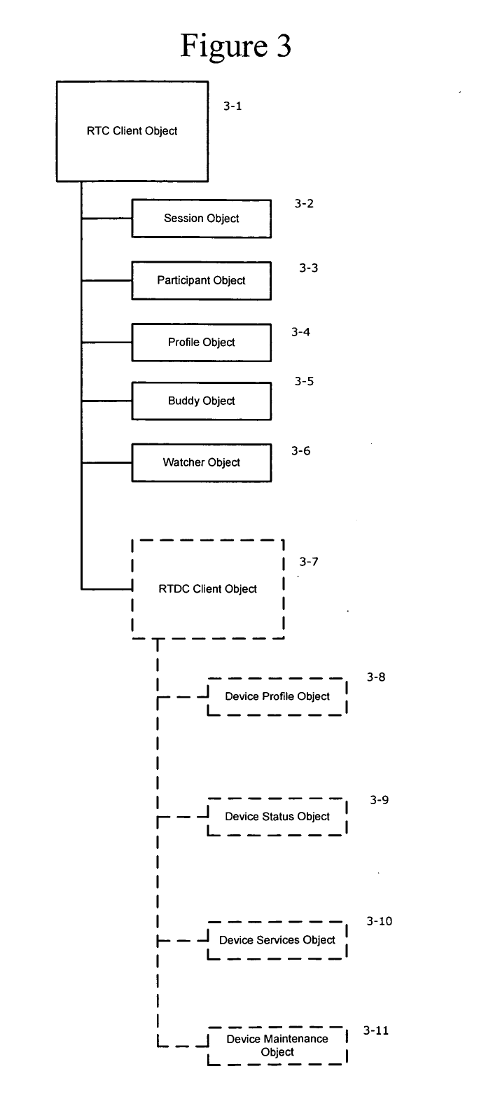

The instant messaging enabled devices of system 1 include a real-time communication (RTC) client, which is a computer-executable process for implementing an Instant Messaging protocol. The RTC client of the present invention is well known in the art, and therefore, a detailed description is omitted herein. However, for completeness, a description of the RTC client as it pertains to the present invention is provided below with respect to FIG. 3.

In addition to the RTC client, the instant messaging enabled devices of system 1 also include a real-time device communications (RTDC) client add-on. The RTDC client add-on, which is a computer-executable process, allows Instant Messaging protocol access to the hardware based features, services, and capabilities of the instant messaging enabled devices. For example, an instant messaging enabled cellular phone or PDA with an RTDC client would use its RTDC client to signal the RTC client on a personal computer that the cellular phone or PDA's battery was getting low. In addition, the RTC client on the personal computer could issue a request to the RTDC client on the cellular phone or PDA to provide the cellular phone or PDA's battery status. A more detailed description of the RTDC client's functionality is described below with respect to FIG. 3.

Also included in System 1 are Public RTC Server 11, RTC Department/Workgroup Server 10.2.1.2, and RTC Maintenance Server 10.2.1.3. Each of these servers makes use of session initiation protocol (SIP) to facilitate Instant Messaging communication. The purpose and functionality of RTC servers is well known in the art and a detailed description is omitted herein. However, for completeness, a brief discussion of how these RTC servers work within system 1 of the present invention will be provided.

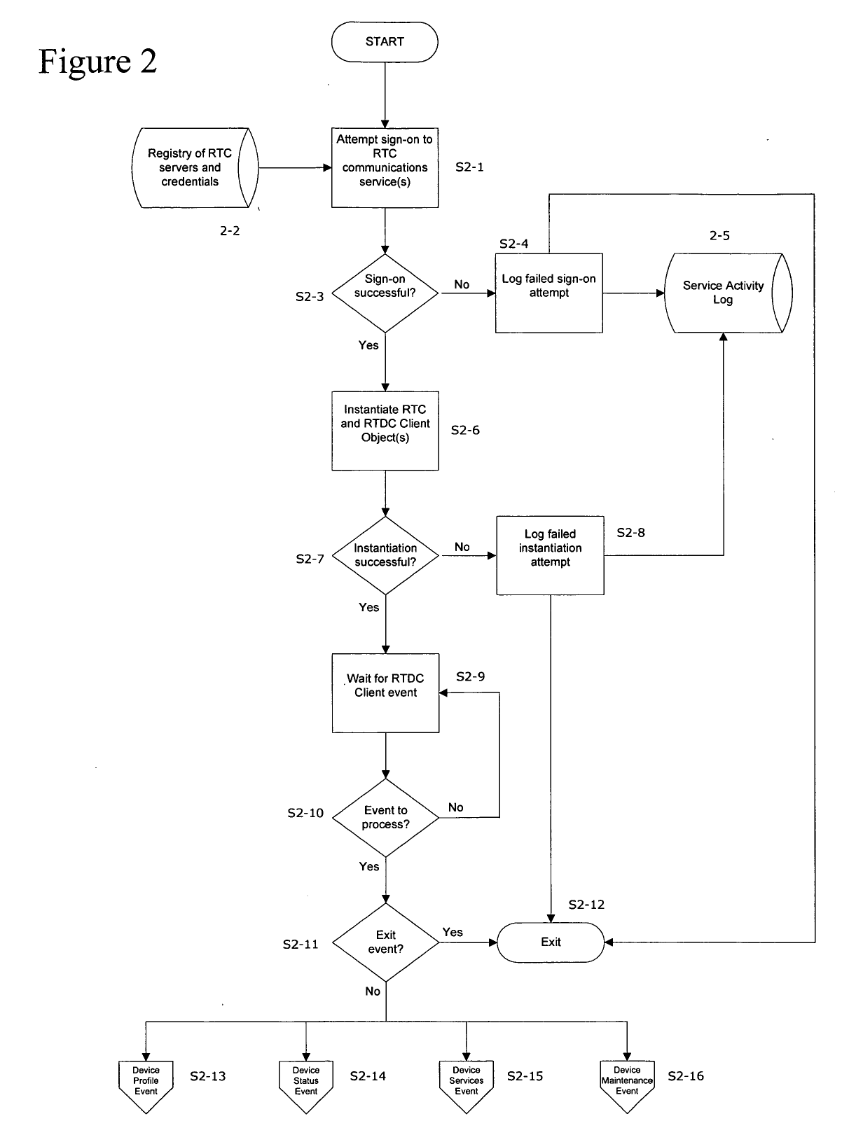

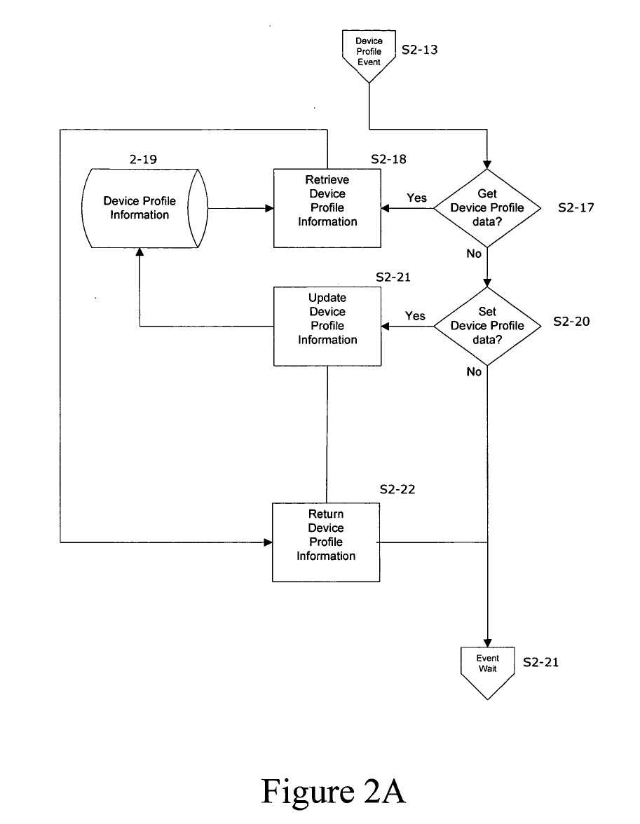

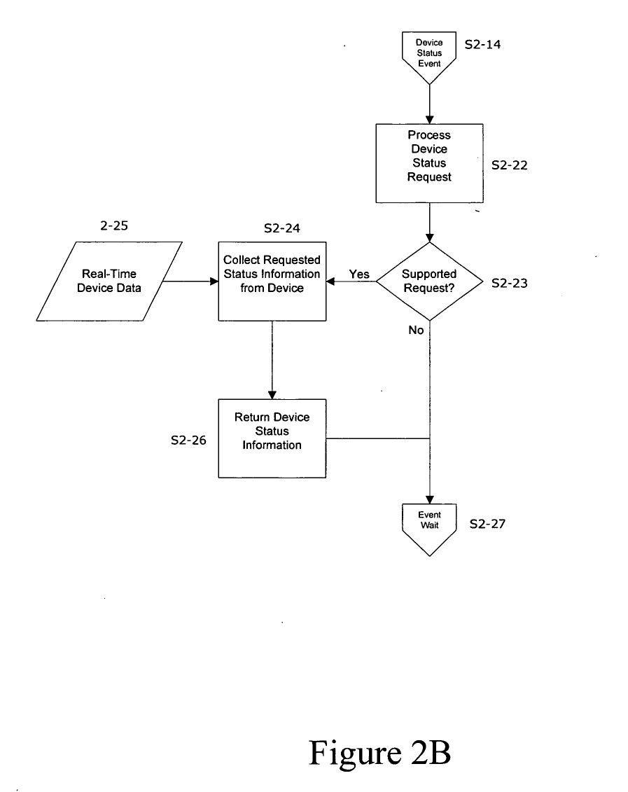

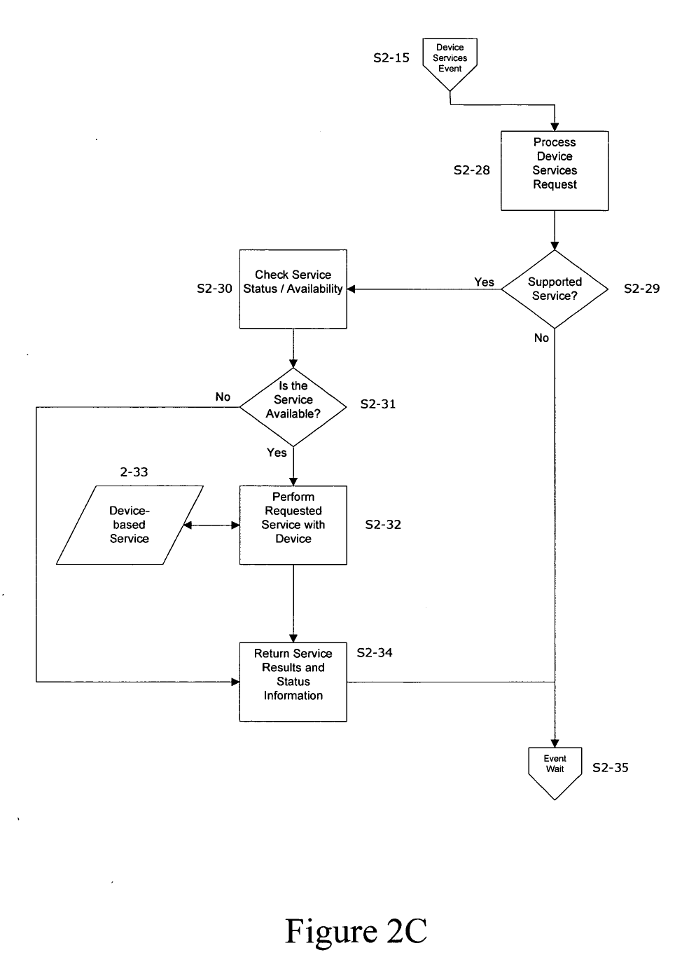

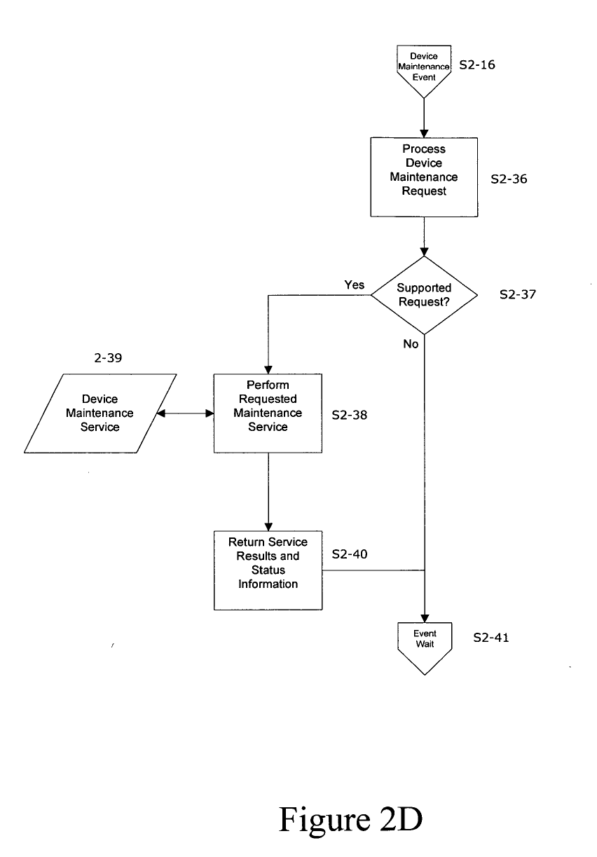

As is known in the art, users of a particular Instant Messaging service register their credentials (e.g., username and password) with a server, i.e., RTC server, of the Instant Messaging service. By registering, users are then capable of connecting to and communicating with other users of the Instant Messaging service. This connection and communication process is accomplished by users of the Instant Messaging service adding other users to their preferred contacts, or buddy, lists, thus enabling users to know when the other party is available. In the present invention, instant messaging enabled devices register with the RTC server and add other instant messaging enabled devices to their buddy lists as described below with respect to FIG. 2. Thus, in the present invention, a first instant messaging enabled device is able to determine if a second instant messaging enabled device is present. And, if second instant messaging enabled device is included in the buddy list of the first instant messaging enabled device, the first instant messaging enabled device can also know whether the second instant messaging enabled device is available to be used.

Returning to FIG. 1, Public RTC Server 11 is used to establish connection and allow communication between instant messaging enabled devices on home network 68 with the instant messaging enabled devices on network 10. The connection is only available for those instant messaging enabled devices that are registered with Public RTC Server 11. The method of registering is described below with respect to FIG. 2.

RTC Development/Workgroup Server 10.2.1.2 is used to establish connection and allow communication between instant messaging enabled devices on network 10. The connection is only available for those instant messaging enabled devices on network 10 that have registered with the RTC Development/Workgroup Server 10.2.1. The method of registering is described below with respect to FIG. 2.

RTC Maintenance Server 10.2.1.3 is also used to establish connection and allow communication between instant messaging enabled devices on network 10. The connection is only available for those instant messaging devices on network 10 that have registered with the RTC Maintenance Server 10.2.1.3. In this case, only those instant messaging enabled devices authorized to perform a maintenance operation and those instant messaging enabled devices that a maintenance operation is allowed to be performed on are registered with the RTC Maintenance Server 10.2.1.3. The method of registering is described below with respect to FIG. 2.

FIG. 3 depicts the architecture of the RTC client as it appears on instant messaging enabled devices 10.13.2.3, 10.2.1.4, 68p, and 68s. More specifically, it shows the client objects and sub-objects that are instantiated in step S2-6 of FIG. 2 described below. In more detail, RTC Client Object 3-1 contains the overall bookkeeping information for the instant messaging enabled device and the other objects, including the following described objects. Session Object 3-2 manages the Instant Messaging session, including session initiation, answering, terminating, and adding participants, etc. Participant Object 3-3 manages/contains a session participant, including participant state information, name, etc. Profile Object 3-4 contains the bookkeeping information for the instant messaging enabled device and manages such information as display name, user name, supported session types, network resources, and accounts, etc. Buddy Object 3-5 manages contact information and status. Watcher Object 3-6 manages information about the state of a “watcher”, i.e., entities that have added this object as a contact. RTDC Client Object 3-7 and its sub-objects are described in further detail below.

FIG. 2 is flowchart describing an exemplary embodiment of an instant messaging enabled device's process according to the present invention. Briefly, a device attempts to log/sign onto an Instant Messaging service, is provided a list of preferred contacts (i.e., buddy list) that includes other instant messaging enabled devices, selects an instant messaging enabled device from the buddy list, and initiates an instant messaging session with the selected instant messaging enabled device.

In more detail, in step S2-1, an instant messaging enabled device attempts to log/sign onto an Instant Messaging server (real-time communications service server) for which membership credentials for the instant messaging enabled device has previously been established. In one embodiment, a user established the membership credentials, while in another embodiment the device itself established the membership credentials. These are just two examples, and any other method of establishing membership credentials that would enable practice of the present invention is applicable. The registry of the real-time communications servers and credentials (2-2) contains the server address information and credentials for logging/signing onto the Instant Messaging server(s) of which the instant messaging enabled device is a member.

Next, in step S2-3, a check is performed to determine whether the credentials provided in step S2-1 are valid by comparing the provided credentials with those stored in the registry (2-2). If the log/sign on fails, flow proceeds to step S2-4, where the failed log/sign on attempt is logged in the service activity log (S2-5). If the instant messaging enabled device successfully logs/signs onto the Instant Messaging service, flow proceeds to step S2-6, where the RTC and RTDC client objects and sub-objects are instantiated and prepared to process requests on instant messaging enabled devices 10.13.2.3, 10.2.1.4, 68p, and 68s.

Returning to FIG. 3, RTDC Client Object 3-7 is instantiated in step S2-6. RTDC Client Object 3-7 contains the overall bookkeeping information for the instant messaging enabled device and contains other objects, including the following described objects. Device Profile Object 3-8 contains the bookkeeping information for the instant messaging enabled device profile, and manages such information as device display name, device name, device features, device settings, supported session types, resources and accounts, etc. Device Status Object 3-9 monitors the current status of the instant messaging enabled device, including common items which could affect usability. Device Services Object 3-10 manages and accesses the services offered by the instant messaging enabled device, including service state information, service name, etc. Device Maintenance Object 3-11 manages and accesses the maintenance services and data offered by the instant messaging enabled device.

Turning back to FIG. 2, after instantiation in step S2-6, flow proceeds to step S2-7, where a check is performed to determine if the instantiation was successful. If the instantiation fails, then in step S2-8, the failed instantiation attempt is logged in the service activity log (S2-5). If the instantiation is successful, flow proceeds to step S2-9, where the process waits for an RTDC Client event. RTDC client events correspond to the above-described RTDC client objects and are described in more detail below with respect to FIGS. 2A-2D.

In step S2-10, a check is performed whether there is an event to process. If there is no event, flow returns to step S2-9 to wait for an event. If there is an event, then flow proceeds to step S2-11. In step S2-11, another check is performed, this time to determine whether to exit the event. If the event is to be exited, then in step S2-12, the process ends, i.e., the instant messaging enabled device exits the Instant Messaging service. If, in step S2-11, the event is not to be exited, then the event to be processed is a Device Profile Event 2-13, Device Status Event 2-14, Device Services Event 2-15, or a Device Maintenance Event 2-16.

If the event to be processed is a Device Profile Event S2-13, then the event is handled by the Device Profile Object 3-8 referenced in FIG. 3. The first step, as shown in step S2-17 in FIG. 2A, is to determine whether there is a request to obtain device profile data. For example, another instant messaging enabled device may request information on the features provided by another instant messaging enabled device. If there is a request to obtain device profile data, then in step S2-18, the device profile information is retrieved from the device profile information storage area 2-19 of the instant messaging enabled device receiving the request. After retrieving the device profile information, in step S2-22, the instant messaging enabled device transmits the information to the entity requesting the information/data.

If there is no request to obtain device profile data then flow proceeds to step S2-20, where a determination is made whether a request to set device profile data has been made. If a request to set device profile data has been made, then in step S2-21, the instant messaging enabled device receiving the request updates the device profile information in the device profile information storage area 2-19 accordingly. For example, the request may be to an instant messaging enabled printer to set the printer's default paper tray. The instant messaging enabled device then provides the updated device profile information to the entity requesting the update. If no request to set the device profile data is made, then in step S2-21, the process waits for the occurrence of another event.

When the event to be processed is a Device Status Event 2-14, then the event is handled by the Device Status Object 3-9 referenced in FIG. 3. In step S2-22 of FIG. 2B, the instant messaging enabled device receiving the event process and examines the event to determine if it is a supported status request element. For examine, an instant messaging enabled device (i.e., personal computer) might request the status of the remaining ink in an instant messaging enabled inkjet printer. If, in step S2-23, it is determined that the status request element is supported, then in step S2-24 the request is processed by extracting the data 2-25 necessary from the instant messaging enabled device (i.e., instant messaging enabled inkjet printer) to service the request. Then, in step S2-26, the instant messaging enabled device packages the results of the request and transmits the results to the requesting entity. If, in step S2-23, the status request element is not supported, then flow proceeds to step S2-27, where the process waits for the occurrence of another event.

A Device Services Event 2-15 is handled by the Device Services Object 3-10 referenced in FIG. 3. Specifically, in step S2-28 of FIG. 2C, an incoming device service request is processed and examined to determine if it is a supported service request. For example, an instant messaging enabled printer will check to determine if an incoming service request is for a service it supports, such as printing. If, the determination is that the incoming device service request is not supported, e.g., an instant messaging enabled printer receiving a data store request, flow proceeds to step S2-35, where the process waits for the occurrence of another event.

If, in step S2-29, if the incoming device service request is supported, then in step S2-30, the status and availability of the service is checked to ensure that the service can be performed. For example, an instant messaging enabled printer may receive a print request, but is unable to perform a printing operation due to a low-ink condition. Next, in step S2-31, a check is made whether the service is available. If the service is not available, then in step S2-34, the results of the service request, i.e., service not available, are packaged and returned to the requesting entity. If the service is available, then in step S2-32, the requested device-based service 2-33 is performed. Then, in step S2-34, the results of the service are packaged and returned to the requesting entity.

The Device Maintenance Object 3-11 referenced in FIG. 3 handles the Device Maintenance Event 2-16. Specifically, in step S2-36 of FIG. 2D, an incoming device maintenance service request is processed and examined to determine if it is a supported request. For example, an instant messaging enabled printer will check to determine if an incoming request to perform a print head alignment operation is a supported request. If, in step S2-37, the incoming device maintenance service request is not supported, then in step S2-41, the process waits for the occurrence of another event. If, however, the incoming device maintenance service request is supported, then flow proceeds to step S2-38, where the requested maintenance service 2-39 is performed. Next, in step S2-40, the results of the maintenance service request are packaged and returned to the requesting entity.

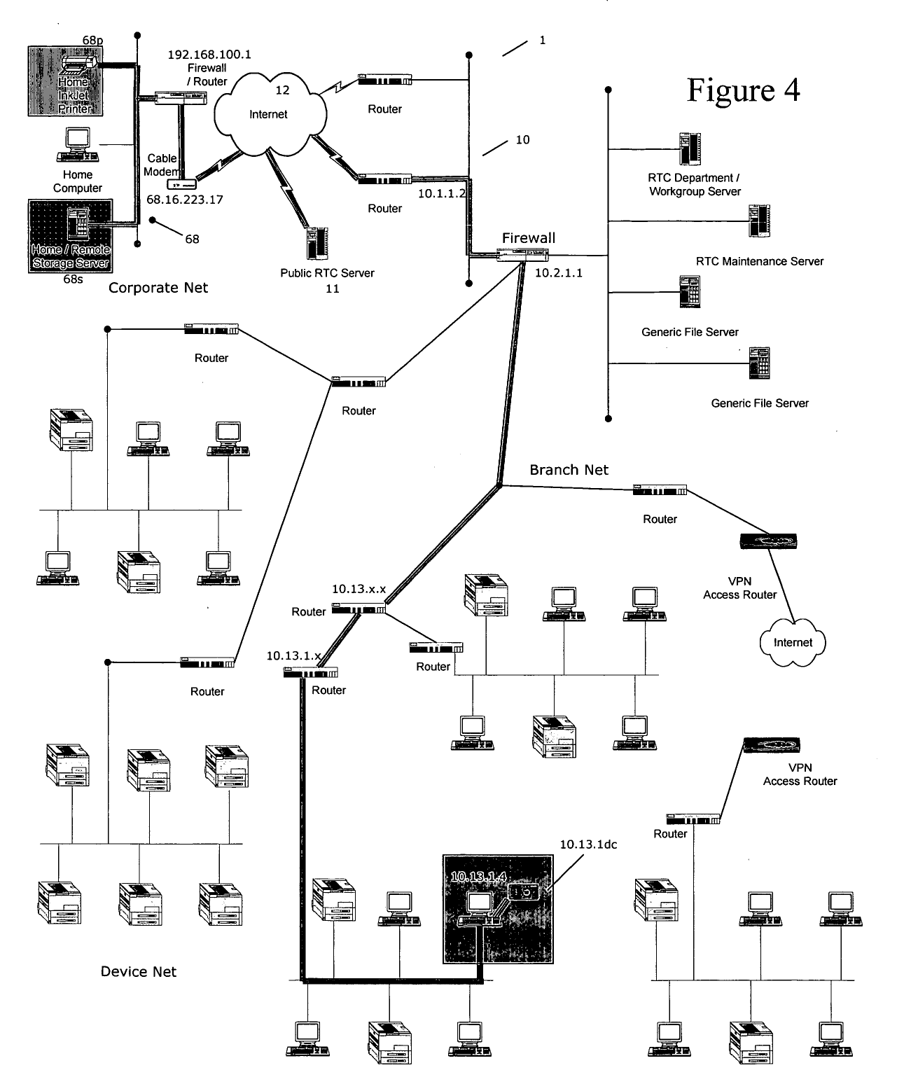

FIG. 4 illustrates an example of the Instant Messaging system according to the present invention. Briefly, FIG. 4 depicts a scenario for sending digital images stored on an instant messaging enabled digital camera to a remote instant messaging enabled storage server in order to copy or off-load digital images stored on the instant messaging enabled digital camera. In addition, the scenario depicted also includes printing some of the digital images from the instant messaging enabled digital camera on a remote instant messaging enabled inkjet printer.

In more detail, personal computer 10.13.1.4 is remotely located from instant messaging enabled home inkjet printer 68p and instant messaging enabled home storage server 68s. Digital images are to be transferred from an instant messaging enabled digital camera 10.13.1dc at the remote location to instant messaging enabled home storage server 68s to save the digital images and to instant messaging enabled inkjet printer 68p to print the digital images.

In order to transfer digital images to instant messaging enabled home storage server 68s and print them out on instant messaging enabled home inkjet printer 68p, instant messaging enabled digital camera 10.13.1dc is connected to personal computer 10.13.1.4 in order to connect instant messaging enabled digital camera 10.13.1 dc to network 10. In the one embodiment, the connection is via a universal serial bus (USB) interface. However, any interface that would enable connection of instant messaging enabled digital camera 10.13.1 dc with network 10 is applicable. For example, if instant messaging enabled digital camera 10.13.1 dc were wirelessly enabled, it could connect directly with network 10 via a wireless interface. In another embodiment, instant messaging enabled digital camera 10.13.1 dc could transfer the digital images to personal computer 10.13.1.4, and the images would be transferred from personal computer 10.13.1.4.

After instant messaging enabled digital camera 10.13.1 dc is connected to network 10, the Instant Messaging service client on instant messaging enabled digital camera 10.13.1 dc is launched (step S2-1 of FIG. 2) and upon successful sign-on onto the Instant Messaging service server, the RTC objects, including the RTDC Client Object 3-7 are instantiated as described above with respect to FIG. 3. Included in the instantiated objects is Buddy Object 3-5, which as described above, manages instant messaging enabled digital camera's 10.13.1dc contact information and status. Upon instantiation of Buddy Object 3-5 on instant messaging enabled digital camera 10.13.1 dc, any instant messaging enabled devices that were previously registered with the Instant Messaging service server are added to the buddy (preferred contacts) list of instant messaging enabled digital camera 10.13.1dc. Instant messaging enabled home storage server 68s and instant messaging enabled home inkjet printer 68p are included in the list, provided they previously registered their credentials with the Instant Messaging service server.

With respect to instant messaging enabled home storage server 68s and instant messaging enabled home inkjet printer 68p, both devices attempt to sign-on to the Instant Messaging service server when they are powered on. Upon successfully signing onto the Instant Messaging service server, the RTDC Client Object 3-7 in each device is instantiated as described above with respect to FIG. 3. In particular, Device Services Object 3-10 is instantiated, which allows instant messaging enabled home storage server 68s and instant messaging enabled home inkjet printer 68p to provide their services via the Instant Messaging service by managing and accessing the storing and printing functionality respectively of each device. In addition, Buddy Object 3-5 is instantiated in each device, which allows each device to appear as available on the buddy list of instant messaging enabled digital camera 10.13.1 dc. The connection between personal computer 10.13.1.4 and instant messaging enabled home storage server 68s and/or instant messaging enabled home inkjet printer 68p is via public RTC 11.

Once the buddy list for instant messaging enabled digital camera 10.13.1 dc, including instant messaging enable home storage server 68s and instant messaging enabled home inkjet printer 68p, is instantiated, instant messaging enabled digital camera 10.13.1dc is able to initiate a data (e.g., digital images) transfer to either instant messaging enabled home storage server 68s or instant messaging enabled home inkjet printer 68p. In one embodiment, instant messaging enabled digital camera 10.13.1dc initiates the data transfer based upon the occurrence of a predetermined event, i.e., data is transferred when the amount of data stored on instant messaging enabled digital camera's 10.13.1dc compact flash memory card exceeds a predetermined threshold. In another embodiment, instant messaging enabled digital camera 10.13.1dc initiates the data transfer based upon user input, i.e., a user of instant messaging enabled digital camera 10.13.1dc instructs the camera to transfer data via the camera's user interface.

As shown in FIG. 4, after initiation of the transfer by instant messaging enabled digital camera 10.13.1dc, the data is sent to instant messaging enabled home storage server 68s and/or instant messaging enabled home inkjet printer 68p over network 10 via personal computer 10.13.1.4, router 10.13.1.x, router 10.13.x.x, firewall 10.2.1.1, and router 10.1.1.2 to the Internet 12. From the Internet 12 the data is sent to cable modem 68.16.223.17. Cable modem 68.16.223.17 then forwards the data to firewall/router 192.168.100.1, where is then sent over home network 68 to instant messaging enabled home storage server 68s and/or instant messaging enabled home inkjet printer 68p.

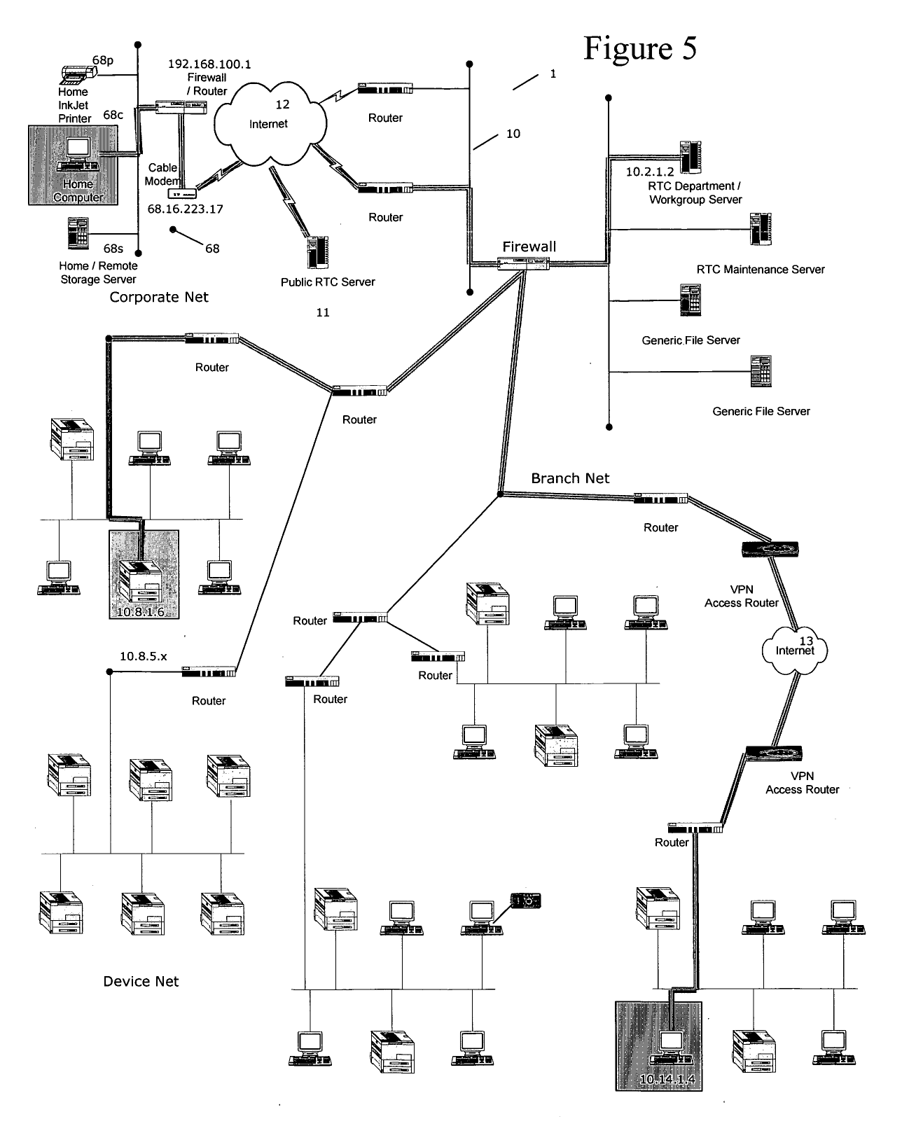

FIG. 5 depicts two examples of remote instant messaging enabled devices connecting to instant messaging enabled devices on network 10. In the first example, instant messaging enabled home computer 68c connects to instant messaging enabled network printer 10.8.1.6. The mechanism of connecting and transferring data from instant messaging enabled home computer 68c to instant messaging enabled network printer 10.8.1.6 is similar to the example described in FIG. 4. Therefore, a detailed description herein is omitted.

In the second example depicted in FIG. 5, instant messaging enabled remote computer 10.14.1.4 connects to instant messaging enabled network printer 10.8.1.6. The mechanism of connecting and transferring data in this example is similar to the example described in FIG. 4 and the first example of FIG. 5. The one difference is that because instant messaging enabled remote computer 10.14.1.4 connects to network 10 via a virtual private network (VPN) connection through the Internet 13, even though it is remotely located from network 10, it is considered to be a device on network 10. Instant messaging enabled home computer 68c on the other hand, is on network 68. Since instant messaging enabled remote computer 10.14.1.4 is a device on network 10, the federated identify is established via RTC Department/Workgroup Server 10.2.1.2 instead of Public RT Server 11.

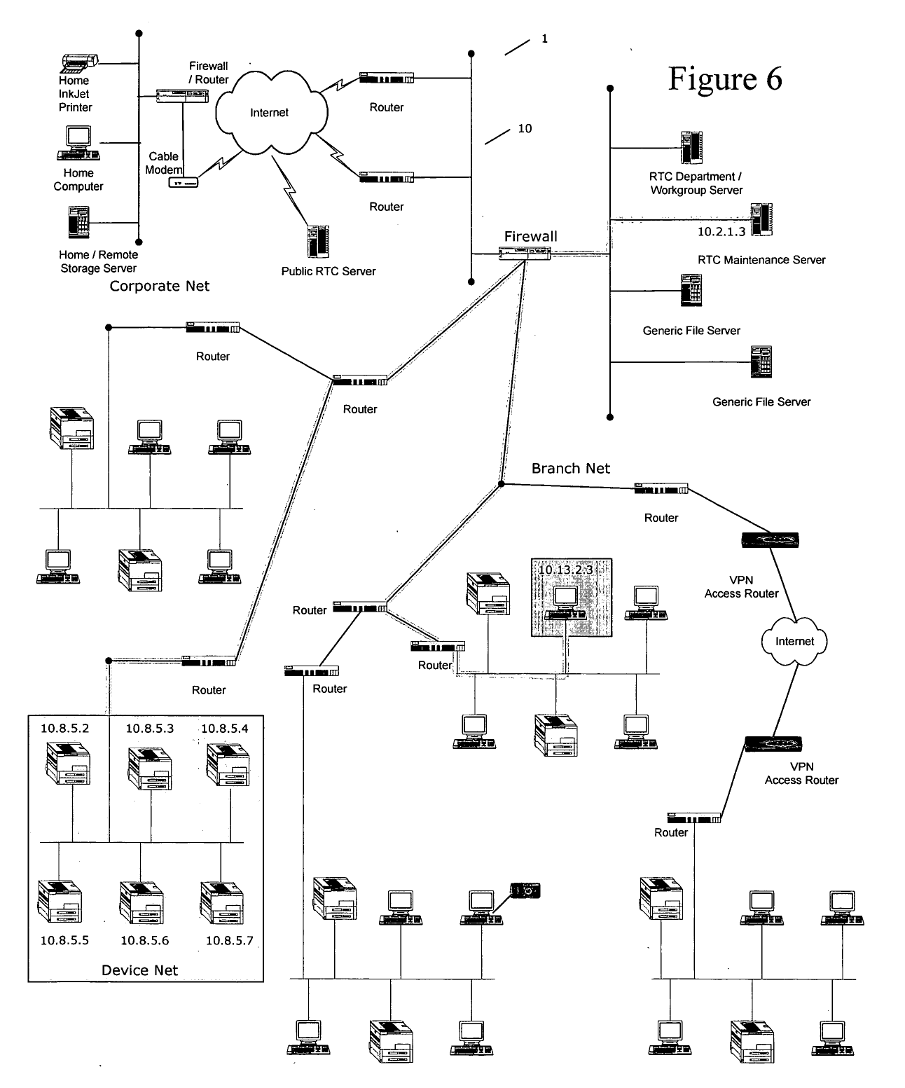

FIG. 6 is an example of performing a maintenance operation using the Instant Messaging service system of the present invention. Instant messaging enabled personal computer 10.13.2.3 initiates a maintenance operation on one more of instant messaging enabled network printers 10.8.5.2 through 10.8.5.7. The maintenance operation is accomplished by instant messaging enabled personal computer 10.13.2.3 implementing the functionality of FIG. 2, while instant messaging enabled network printers 10.8.5.2 through 10.8.5.7 implement the functionality of FIG. 2 and FIG. 2D. As shown in FIG. 6, RTC Maintenance Server 10.2.1.3 is used to establish and maintain the federated identify of instant messaging enabled personal computer 10.13.2.3 and instant messaging enabled network printers 10.8.5.2 through 10.8.5.7.

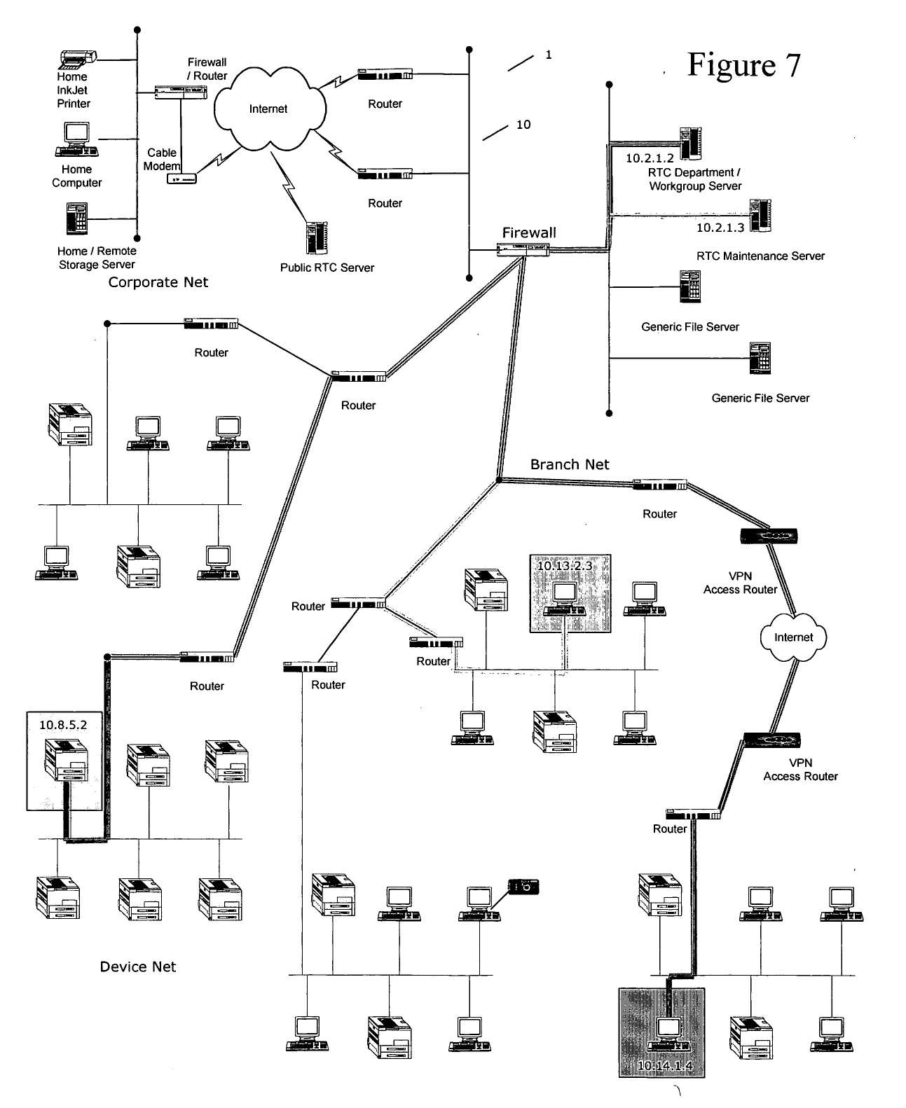

FIG. 7 is an example of performing a troubleshooting and maintenance operation using the Instant Messaging system of the present invention. The maintenance operation is accomplished by instant messaging enabled personal computer 10.14.1.4 implementing the functionality of FIG. 2, while instant messaging enabled network printer 10.8.5.2 implements the functionality of FIGS. 2 and 2D. RTC Maintenance Server 10.2.1.3 establishes the federated identity of user device 10.14.1.4 and network printer 10.8.5.2.

The troubleshooting operation is accomplished by instant messaging enabled personal computer 10.13.2.3 implementing the functionality of FIG. 2, while instant messaging enabled network printer 10.8.5.2 implements the functionality of FIGS. 2 and 2B. In this case, RTC Department/Workgroup Server 10.2.1.2 establishes the federated identity of instant messaging enabled personal computer 10.13.2.3 and instant messaging enabled network printer 10.8.5.2.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

What is claimed is:

1. A method for communicating between at least two instant messaging enabled devices, comprising:
registering the at least two instant messaging enabled devices;
adding an instant messaging identity associated with at least one of the instant messaging enabled devices at at least one of the instant messaging enabled devices other than the at least one instant messaging enabled device associated with the instant messaging identity;
initiating an instant messaging session between a first and a second of the at least two instant messaging enabled devices;
receiving device information from the first of the at least two instant messaging enabled devices at the second of the at least two instant messaging enabled devices;
determining, based on the received device information, whether the first of the at least two instant messaging enabled devices supports a service or capability sought by the second of the at least two instant messaging enabled devices;
requesting performance of a service or function based on the determination; and
performing the requested service or function.

2. A method according to claim 1, wherein the at least two instant messaging devices are registered on a session initiation protocol enabled server.

3. A method according to claim 1, wherein the instant messaging identity is added as a preferred contact.

4. A method according to claim 1, wherein the second of the at least two instant messaging enabled devices requests the first of the at least two instant messaging enabled devices to perform the service or function.

5. A method according to claim 1, wherein requesting performance of a service or function includes transferring data associated with the requested service or function in a case where data is needed in order to perform the service or function.

6. A method according to claim 1, wherein the requested service or function includes printing or data storing.

7. Computer-executable process steps for causing a computer to execute the method of claim 1.

8. A computer-readable storage medium for storing the computer-executable process steps of claim 7.

9. A system for communicating between instant messaging enabled devices, comprising:
at least two instant messaging enabled devices;
a server,
wherein the at least two instant messaging enabled devices register with the server,
wherein a first of the at least two instant messaging enabled devices initiates an instant messaging session with a second of the at least two instant messaging enabled devices,
wherein, the second of the at least two instant messaging enabled devices receives device information from the first of the at least two instant messaging enabled devices
wherein the second of the at least two instant messaging enabled devices determines, based on the received device information, whether the first of the at least two instant messaging enabled devices supports a service or a capability sought by the second of the at least two instant messaging enabled devices,
wherein the second of the at least two instant messaging enabled devices requests the first of the at least two instant messaging enabled device to perform a service or function based on the determination, and
wherein the first of the at least two instant messaging enabled devices performs the service or function requested by the second of the at least two instant messaging enabled devices,

10. A system according to claim 9, wherein the server is a session initiation protocol enabled server.

11. A system according to claim 9, wherein the request to perform a service or function includes transferring data associated with the requested service or function in a case where data is needed in order to perform the service or function.

12. A system according to claim 9, wherein the requested service or function includes printing or data storing.

13. An instant messaging enabled device comprising:
a registration unit for registering the instant messaging device;
an adding unit for adding an instant messaging identity of at least one other instant messaging enabled device;
an initiating unit for initiating an instant messaging session between the instant messaging enabled device and at least one other instant messaging enabled device;
a receiving unit for receiving device information from the at least one other instant messaging enabled device;
a determining unit for determining, based on the device information received by the receiving unit, whether the at least one other instant messaging enabled device supports a service or capability sought by the instant messaging device;
a requesting unit for requesting the at least one other instant messaging enabled device to perform a service or function based on the determination.

14. An instant messaging enabled device according to claim 13, wherein the registration unit registers the instant messaging enabled device on a session initiation protocol enabled server.

15. An instant messaging enabled device according to claim 13, wherein requesting to perform a service or function includes transferring data associated with the requested service or function in a case where data is needed in order to perform the service or function.
